(19) United States
(12) Patent Application Publication
(10) Pub. No.: US 2026/0290864 A1
(43) Pub. Date: Sep. 24, 2026

(54) SENSOR APPARATUS AND METHOD

(71) Applicant: National Research Council of Canada, Ottawa (CA)

(72) Inventors: Cheng Hu, Richmond (CA); Lei Zhang, Delta (CA); Jun Shen, Richmond (CA)

(21) Appl. No.: 19/474,282

(22) PCT Filed: Apr. 12, 2024
(86) PCT No.: PCT/CA2024/050464

§ 371 Date: Oct. 10, 2025

Related U.S. Application Data
(60) Provisional application No. 63/458,755, filed on Apr. 12, 2023.

(51) Int. Cl. H01M 8/04664; H01M 8/04089

(52) U.S. Cl. CPC H01M 8/04664; H01M 8/04089; H01M 2250/20

(57) ABSTRACT

A contaminant sensor for use in an air flow path of a fuel cell system upstream of a fuel cell, the fuel cell including a cell catalyst layer having a catalyst layer composition. The sensor may include a detection electrode including a sensing element having a composition that is the same as the catalyst layer composition, such that the output of the sensor can correspond to the response of the fuel cell. The output of the sensor may be processed to detect a contamination event without applying a calibration factor to the output. When contaminants are detected or detected at a quantity or rate above a predetermined threshold, an air filter may be replaced or an alert may be generated to warn a user to replace an air filter. The sensor may be manufactured by using a sample of the catalyst, without the composition of the sample being disclosed.

### CROSS REFERENCE TO RELATED APPLICATION

This application claims priority to United States Patent Application No. 63/458,755 filed on Apr. 12, 2023, the entire contents of which are hereby incorporated herein by reference.

### FIELD

The present disclosure relates generally to sensors, and particularly to chemical sensors for use with fuel cell air flow paths.

### INTRODUCTION

The following paragraphs are not an admission that anything discussed in them is prior art or part of the knowledge of persons skilled in the art.

Fuel cells, such as proton exchange membrane fuel cells (PEMFC), have been developed for use in various systems, such as vehicles. In many cases, a system includes a fuel cell stack which utilizes ambient air as a source of oxygen for internal electrochemical reaction with hydrogen.

Air contaminants influence the performance and life time of fuel cell stacks. Contaminated air entering the fuel cell stack at the cathode side may cause catalyst degradation or damage gas diffusion layers or membranes in the stack. Chemical contaminants include sulfur compounds (e.g., SOₓ, H₂S), nitrogen compounds (e.g., NOₓ, NO), ammonia (NH₃), carbon monoxide, volatile organic compounds and other known or unknown contaminants.

To prevent the fuel cell stack from a possibly irreversible degradation and damage caused by contaminants in air, an air filter may be used in an air intake system to continuously filter out dust and contaminant chemicals. However, exposed to a contaminated gas environment, the air filter itself also suffers degradation/saturation and gradually loses its filtering function. As it is difficult to predict the air quality of the air that the air filter will be exposed to, filter functionality over time is difficult to predict. In addition, there are presently few options available to provide accurate real-time monitoring of the current state of the air filter itself.

Sensors may be used to monitoring air quality downstream of a filter. However, there are many air contaminants that influence the performance and life time of fuel cell stacks. Many sensors are suitable for detecting only one or a few contaminants, and including a sensor for each contaminant results in excessive costs and/or space requirements in the air intake. Further, these multiple sensors may have cross-sensitivity issues or sensing selectivity issues with one another which can lead to reading errors when multiple contaminants are present. Additionally, the performance and life time of a fuel cell stack may be influenced by a contaminant for which no sensor is provided, such as a contaminant that was not identified as a contaminant at the time of manufacturing.

While there are sensors which monitor broadly for relevant contaminants (e.g., sensors disclosed in Japanese Patent App. Pub. No. 2008/282680), differences between sensor output and fuel cell response can require sensor calibration steps.

### BRIEF DESCRIPTION OF THE DRAWINGS

The drawings included herewith are for illustrating various examples of apparatuses and methods of the present disclosure and are not intended to limit the scope of what is taught in any way.

FIG. 1 is a schematic diagram of a fuel cell.

FIG. 2 is perspective view of a fuel cell system.

FIG. 3 is a circuit diagram of a first contaminant sensor.

FIG. 4 is a circuit diagram of a second contaminant sensor.

FIG. 5 is a schematic diagram of a contaminant monitoring system.

FIG. 6 is a flow chart of a method of producing a contaminant sensor.

FIG. 7 is a flow chart of a method of monitoring for degradation of an intake filter.

FIG. 8 is a graph of a cyclic voltammogram curve from a cyclic voltammogram scan following N₂ purging.

FIG. 9 is a graph of a cyclic voltammogram curve from a cyclic voltammogram scan following O₂/N₂ mixed gas purging.

FIG. 10 is a graph of a cyclic voltammogram curve from a cyclic voltammogram scan following 0.5 ppm SO₂ mixed gas purging.

FIG. 11 is a graph of a cyclic voltammogram curve from a cyclic voltammogram scan following 1 ppm SO₂ mixed gas purging.

FIG. 12 is a graph of a cyclic voltammogram curve from a cyclic voltammogram scan following 2 ppm SO₂ mixed gas purging.

FIG. 13 is a graph of a linear sweep voltammogram curve from a linear sweep voltammogram scan following O₂/N₂ mixed gas purging.

FIG. 14 is a graph of a linear sweep voltammogram curve from a linear sweep voltammogram scan following 0.5 ppm SO₂ mixed gas purging.

FIG. 15 is a graph of a linear sweep voltammogram curve from a linear sweep voltammogram scan following 1 ppm SO₂ mixed gas purging.

FIG. 16 is a graph of a linear sweep voltammogram curve from a linear sweep voltammogram scan following 2 ppm SO₂ mixed gas purging.

FIG. 17 is a graph of a cyclic voltammogram curve from a cyclic voltammogram scan following extended 2 ppm SO₂ mixed gas purging.

FIG. 18 is a graph of a linear sweep voltammogram curve from a linear sweep voltammogram scan following extended 2 ppm SO₂ mixed gas purging.

FIG. 19 is a graph of a cyclic voltammogram curve from a cyclic voltammogram scan following artificial O₂/N₂ mixed gas purging after the extended 2 ppm SO₂ mixed gas purging.

FIG. 20 is a graph of a linear sweep voltammogram curve from a linear sweep voltammogram scan following artificial O₂/N₂ mixed gas purging after the extended 2 ppm SO₂ mixed gas purging.

FIG. 21 is a graph combining the curves of FIGS. 9-12.

FIG. 22 is a graph combining the curves of FIGS. 13-16, 18 and 20.

### DETAILED DESCRIPTION

Various apparatuses or methods will be described below to provide an example of an embodiment of each claimed invention. No embodiment described below limits any claimed invention and any claimed invention may cover apparatuses and methods that differ from those described below. The claimed inventions are not limited to apparatuses and methods having all of the features of any one apparatus or method described below, or to features common to multiple or all of the apparatuses or methods described below. It is possible that an apparatus or method described below is not an embodiment of any claimed invention. Any invention disclosed in an apparatus or method described below that is not claimed in this document may be the subject matter of another protective instrument, for example, a continuing patent application, and the applicant(s), inventor(s) and/or owner(s) do not intend to abandon, disclaim or dedicate to the public any such invention by its disclosure in this document.

The teachings described herein relate to a contaminant sensor and method of producing the contaminant sensor. The contaminant sensor includes a sensing element that is made up of a material having a composition the same as a composition of a catalyst material of the fuel cell that the sensor is used with, such that the output of the sensor corresponds to the response of the fuel cell.

The sensor may be used without a calibration step, since the output of the sensor is directly correlated to the response of the fuel cell. Also, or alternatively, the sensor may be manufactured by using a sample of the catalyst, without the composition of the sample being disclosed. The catalyst composition may thus remain a secret with a supplier of the sample even while contaminant sensors are produced by another party for use with the fuel cell.

The teachings described herein also relate to monitoring air quality in an air inlet of a fuel cell system and a system for monitoring air quality. Monitoring for contaminants, such as SO₂, which may poison the catalyst of a fuel cell may allow for improved fuel cell performance and/or life span. When contaminants are detected or detected at a quantity or rate above a predetermined threshold, an air filter may be replaced or an alert generated to warn a user to replace an air filter. The output of the sensor may be used to monitor for a contamination event without applying a calibration factor to the output of the sensor.

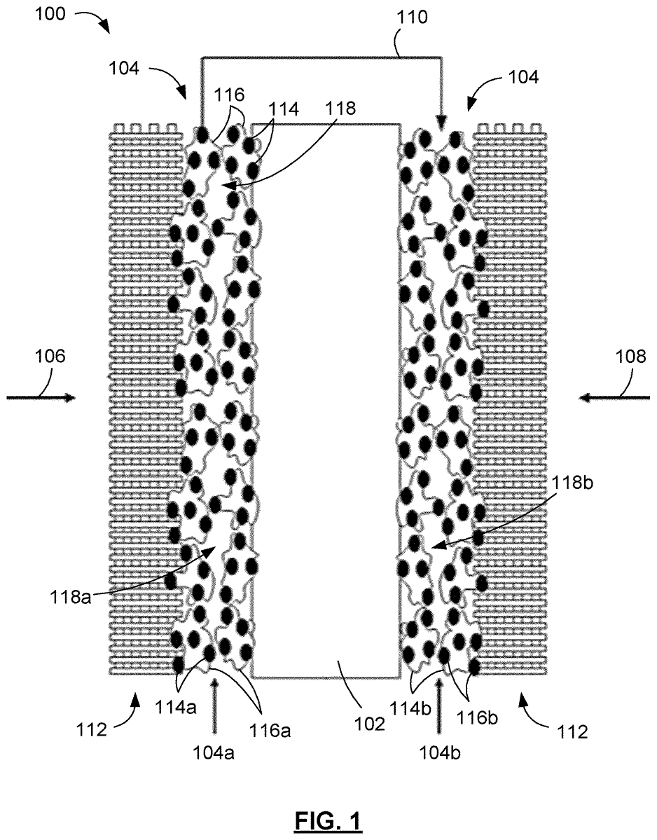

As exemplified in FIG. 1, a fuel cell 100 includes a membrane 102 (e.g., Nafion™) between catalyst layers 104. The fuel cell 100 may be a proton exchange membrane fuel cell. A fuel supply 106 (e.g., hydrogen fuel) is provided to the catalyst layer 104 on one side of the membrane 102 and an air supply 108 is provided to the catalyst layer 104 on the opposite side of the membrane 102 to generate a flow of electrons 110. It will be appreciated that the fuel cell 100 may also include diffusion layers 112, as exemplified.

The catalyst layers 104 each include catalyst material 114 (e.g., platinum) supported by support material 116 (e.g., carbon support), and may include one or more additional components 118 (e.g., polytetrafluoroethylene and/or an ionomer solution). The catalyst material 114 may comprise or consist of platinum or may comprise or consist of a non-platinum catalyst component, such as a non-platinum metal.

The exemplary fuel cell 100 of FIG. 1 has identical catalyst layers 104 used on both the fuel supply side and the air supply side, however it will be appreciated that the catalyst layer 104a on the fuel supply side may be different from the catalyst layer 104b on the air supply side. The catalyst layer 104a on the fuel supply side may include different components and/or different ratios of components than the catalyst layer 104b. In some examples, the catalyst material 114a on the fuel supply side may be different from the catalyst material 114b on the air supply side.

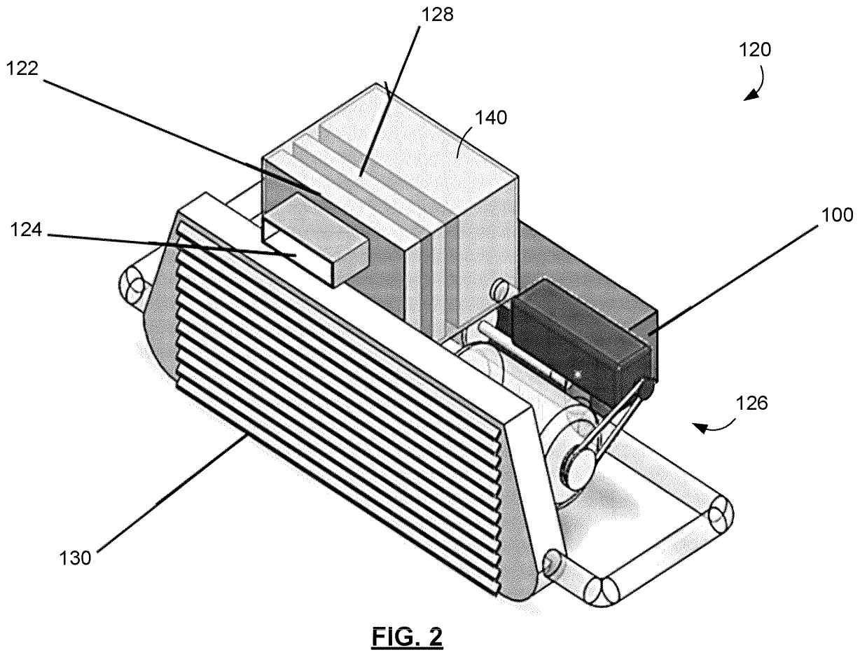

As exemplified in FIG. 2, the fuel cell 100 may be used in a fuel cell system 120. The fuel cell system 120 includes an air flow path 122 extending between a path inlet 124 and a path outlet 126 (e.g., directly out of a housing of the fuel cell 100, as exemplified). The fuel cell 100 is in the air flow path 122, and the air supply 108 is provided via the air flow path 122. A filter 128 is in the air flow path 122 between the path inlet 124 and the fuel cell 100. It will be appreciated that the fuel cell system 120 may be, e.g., a vehicle such as an automobile, boat, or plane. The air flow path 122 may extend through an air cooling device 130 upstream of the fuel cell (e.g., an air-air intercooler), the air cooling device 130 may be downstream of the filter 128.

A contaminant sensor 140 is in the air flow path 122 between the filter 128 and the fuel cell 100. The contaminant sensor 140 may be used to monitor the air quality in the air flow path 122 downstream of the filter 128 and upstream of the fuel cell 100.

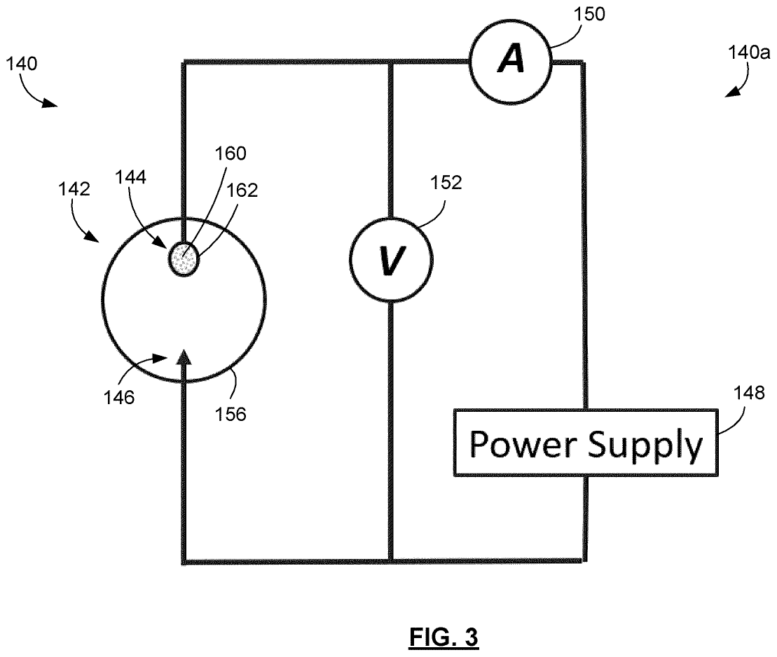

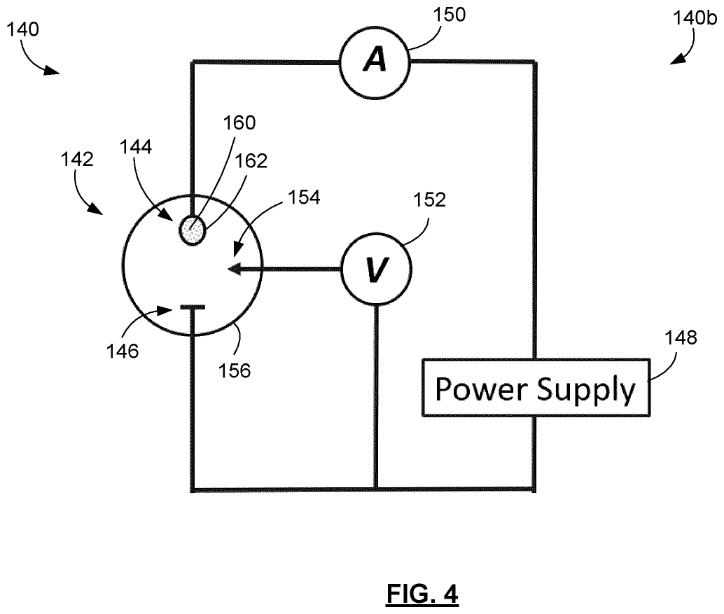

It will be appreciated that various types of sensor structures may be used for the contaminant sensor 140. As exemplified in FIGS. 3 and 4, the contaminant sensor 140 may include a plurality of electrodes 142, including a detection electrode 144 and an auxiliary electrode 146. The contaminant sensor 140 may include a power supply 148 coupled between the detection electrode 144 and the auxiliary electrode 146. An output of the contaminant sensor 140 may include a current flowing to or from the detection electrode 144, and the contaminant sensor 140 may include an ammeter 150 to measure current flowing to or from the detection electrode 144. A voltmeter 152 is provided to measure electric potential.

As exemplified in FIG. 3, the contaminant sensor 140 may be a two-electrode sensor 140a operable to apply a known potential between the detection electrode 144 and the auxiliary electrode 146. As exemplified in FIG. 4, the contaminant sensor 140 may be a three-electrode sensor 140b including a reference electrode 154 to measure the potential of the detection electrode 144 against. It will be appreciated that electrodes of the sensor may be joined by an electrolyte in a sensing cell 156. As exemplified in FIGS. 3 and 4, the detection electrode 144 of the contaminant sensor 140 includes a sensing element 160.

The inventors have discovered that matching a composition of a sensing element of the contaminant sensor 140 to the composition of the catalyst 104 of the fuel cell 100 results in a sensor output of the contaminant sensor 140 that corresponds to the response of the fuel cell 100. The sensor composition of the sensing element 160 establishes a direct correlation between sensor response and fuel cell degradation. The sensor 140 responds to contaminants the same way and simultaneously as the catalyst layer 104 of the fuel cell 100 reacts with the same contaminants.

The sensing element 160 has a composition that is based on the material of the fuel cell catalyst layer 104 of the fuel cell 100 for which the sensor is prepared. In some embodiments, the air supply side catalyst layer 104b has a composition that is different from a composition of the fuel supply side catalyst layer 104a, and the composition of the sensing element 160 is based on the composition of the air supply side catalyst layer 104b.

As described above, the catalyst layer 104 may have a composition that is a combination of at least two different components. The catalyst layer 104 may have a composition that is a combination of at least four different components (e.g., the catalyst material 114, the supporting material 116, and a solution 118 that includes at least two components). The catalyst layer 104 may have a composition that includes platinum and at least one additional component. The catalyst layer 104 may have a composition that includes platinum and at least three additional components. The catalyst layer 104 may have a composition that includes platinum, a supporting component (e.g., carbon support), and at least one additional component. The catalyst layer 104 may have a composition that includes platinum, a supporting component (e.g., carbon support), and at least one additional component or at least two additional components.

In some embodiments, the sensing element comprises or consists of one or more of the materials of the catalyst layer 104 of the fuel cell 100 for which the sensor is prepared. In some embodiments, the sensing element comprises or consists of all of the materials of the catalyst layer 104 of the fuel cell 100 for which the sensor is prepared. The materials may be provided in the sensing element 160 in the same ratios as provided in the fuel cell layer, or in different ratios.

In some embodiments, the sensing element 160 comprises or consists of the catalyst material 114 of the fuel cell 100 for which the sensor is provided. In some embodiments, the sensing element 160 comprises or consists of the catalyst material 114 and a support material, and the support material may be the same support material 116 as that of the fuel cell 100. In some embodiments, the sensing element 160 comprises or consists of all of the components of the catalyst layer 104 of the fuel cell 100 for which the sensor is provided.

Monitoring this sensor output provides a real-time indicator of air quality, and a corresponding indicator of the condition of the filter 128. As the sensing element responds the same way as the catalyst layer 104 of the fuel cell 100, the contaminant sensor 140 is applicable to any gas mixture with unknown contaminants and avoids the sensing selectivity issues of many other gas sensors.

The inventors have discovered that in some embodiments no calibration is needed. The output of the sensor is a reliable indication of the response of the fuel cell, and, as described further elsewhere herein, in some embodiments the contaminant sensor may be used without a calibration step and/or without applying a calibration factor when calculating whether contaminants are detected.

In some embodiments, the contaminant sensor 140 includes a coating 162 over the sensing element 160. The coating 162 may be formed of the same material as the membrane 102 of the fuel cell 100. The membrane layer 102 may have a composition that includes a membrane component (e.g., Nafion™).

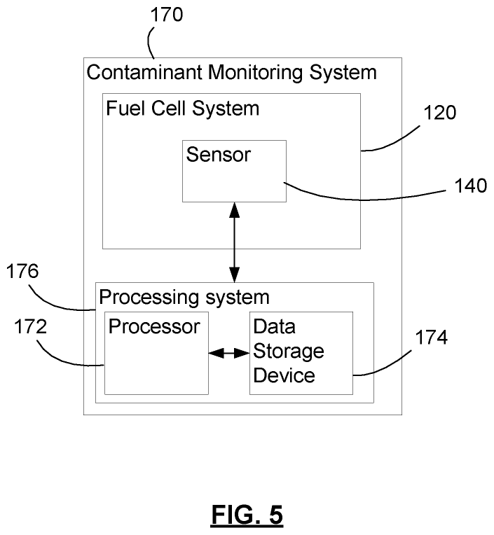

As exemplified in FIG. 5, the fuel cell system 120 may be part of a contaminant monitoring system 170. The contaminant monitoring system 170 includes the fuel cell system 120 with the contaminant sensor 140 in the air flow path 122. The contaminant monitoring system 170 also includes a detection system 176 to detect a contamination event. The detection system 176 may be a simple alert or alarm trigger, such as via a simple circuit that responds to an output of the sensor 140. In some embodiments, the detection system 176 includes at least one processor 172 communicatively coupled to the contaminant sensor 140 to receive an output of the contaminant sensor 140. In some embodiments at least one data storage device 174 may be communicatively coupled to the at least one processor 172.

The at least one data storage device 174 includes instructions stored thereon for operating the at least one processor 172. The instructions include instructions for operating the at least one processor 172 to receive the output of the contaminant sensor 140 and process the output of the contaminant sensor to detect a contamination event, without applying a calibration factor to the output. The instructions may also include instructions for operating the at least one processor 172 to generate an alert in response to detecting the contamination event. In one embodiment the instruction may allow for setting of threshold levels of contamination, below which the alert will not be generated.

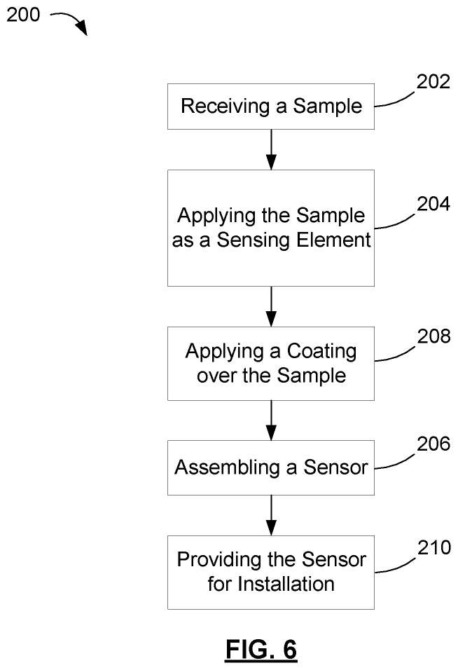

Referring now to FIG. 6, illustrated is a flow chart of a method 200 of producing a contaminant sensor (e.g., contaminant sensor 140), such as for use in an air flow path of a fuel cell system upstream of a fuel cell (e.g., in the air flow path 122). The fuel cell may be a proton exchange membrane fuel cell.

The method 200 includes, at step 202, receiving a sample of catalyst material of the fuel cell. The sample has a sample composition that is the same as the catalyst composition of the catalyst material. In some embodiments, the sample is received from a third party and the sample composition is an undisclosed composition.

The method 200 also includes, at step 204, applying the sample of the cell catalyst material as a sensing element of a detection electrode (e.g., detection electrode 144). Applying the sample of the cell catalyst material as the sensing element on the detection electrode may include applying the sample without knowing the sample composition. Accordingly, a party supplying the sample may know the sample composition but utilize the services of another party to build sensors without revealing the sample composition to the other party. The composition of the catalyst may be a secret (e.g., a trade secret) that the supplying party does not wish to reveal.

At step 206, method 200 includes assembly the contaminant sensor. The contamination sensor includes a plurality of electrodes (e.g., electrodes 142), including the detection electrode.

The method 200 may include, at step 208, applying a coating (e.g., coating 162) over the sample. The coating has a coating composition that is the same as a membrane composition of a membrane of the fuel cell. The method 200 may include, at step 210, providing the contaminant sensor for installation in the fuel cell system without knowing the sample composition.

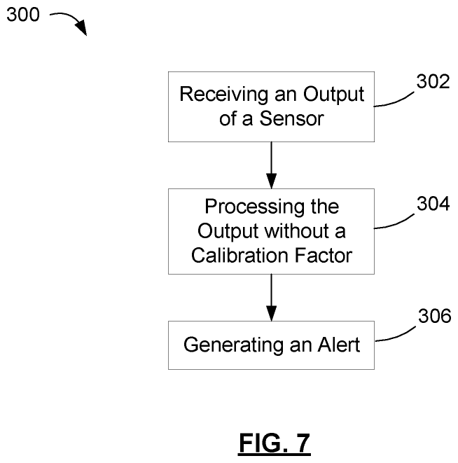

Referring now to FIG. 7, illustrated is a flow chart of a method 300 of monitoring for degradation of an intake filter of a fuel cell system (e.g., fuel cell system 120).

The method 300 includes, at step 302, receiving an output of a contaminant sensor (e.g., contaminant sensor 140). The contaminant sensor includes a detection electrode arranged in an air flow path between the intake filter and a fuel cell of the fuel cell system. The detection electrode includes a sensing element having a composition the same as a catalyst composition of a catalyst of the fuel cell.

The method 300 includes, at step 304, processing the output of the contaminant sensor to detect a contamination event, without applying a calibration factor to the output. The method 300 may include, at step 306, generating an alert in response to detecting the contamination event. The alert may include a signal indicating a need to replace the air filter.

While the sensor 140 has been described as based on a fuel cell, in some embodiments a sensor is based on any electrochemical device that necessarily includes a catalyst layer (e.g., a fuel cell or another electrochemical device).

### EXAMPLES

Other aspects and features of the present disclosure will become apparent upon review of the following examples of the description, which are intended to be illustrative but non-limiting.

### Device Fabrication

A glassy carbon rotating disk electrode was polished using 0.5 μm of alumina powder. The glassy carbon rotating disk electrode was sonicated for 5 minutes in water. The glassy carbon rotating disk electrode was rinsed with acetone and water.

Catalyst ink was prepared. The catalyst ink was prepared using a Platinum (40 wt %) catalyst powder weighed and mixed with Isopropyl alcohol (IPA) and water accordingly so that the concentration ratio was 0.5 mg catalyst/mL with 19:1 IPA to water ratio in volume. The mixture was further subjected to ultrasonically blending for 20-30 minutes to obtain the catalyst ink. 20 μL of the catalyst ink was coated onto the glassy carbon disk using a micro syringe. The catalyst ink was then dried.

0.1 wt % Nafion™ solution was prepared. The Nafion™ solution was prepared using 0.5 g of a 5 wt % Nafion™ solution. This solution was diluted by adding 15 ml of water and 15 ml of IPA to obtain the 0.1 wt % Nafion™ solution. After the catalyst ink dried, 10 μL of the 0.1 wt % Nafion™ solution was added onto the dried catalyst ink. The 0.1 wt % Nafion™ solution was then dried naturally at room temperature.

The total catalyst loading was controlled to 40 μμg Pt/cm² respective to the geometric surface area (GSA) of the glassy carbon disk electrode (the geometric surface area being 0.2 cm² ).

The contaminant sensor was constructed using the glassy carbon rotating disk electrode coated with layers of catalyst ink and 0.1 wt % Nafion™ solution as a detection electrode, a saturated calomel electrode (SCE) as the reference electrode, and a Platinum wire counter electrode connected via a 0.5 M H₂SO₄ electrolyte.

### Device Testing

Cyclic voltammetry was used to evaluate the performance of the synthesized electrode in the presence of different gas concentrations, namely nitrogen gas, artificial O₂/N₂ mixed gas, 0.5 ppm SO₂ mixed gas, 1 ppm SO₂ mixed gas and 2 ppm SO₂ mixed gas. CorrView™ and CView™ software were used to record the electrochemical data including the cyclic voltammograms (CV) and linear sweep voltammograms (LSV), while the Solartron 1287™ potentiostat was used to control the voltage. Each time the electrolyte was purged with a particular gas or concentration, the required cyclic voltammograms followed by the linear sweep voltammograms were recorded as described below before moving on to the stability and/or reversibility tests described below.

### Cyclic Voltammogram Testing

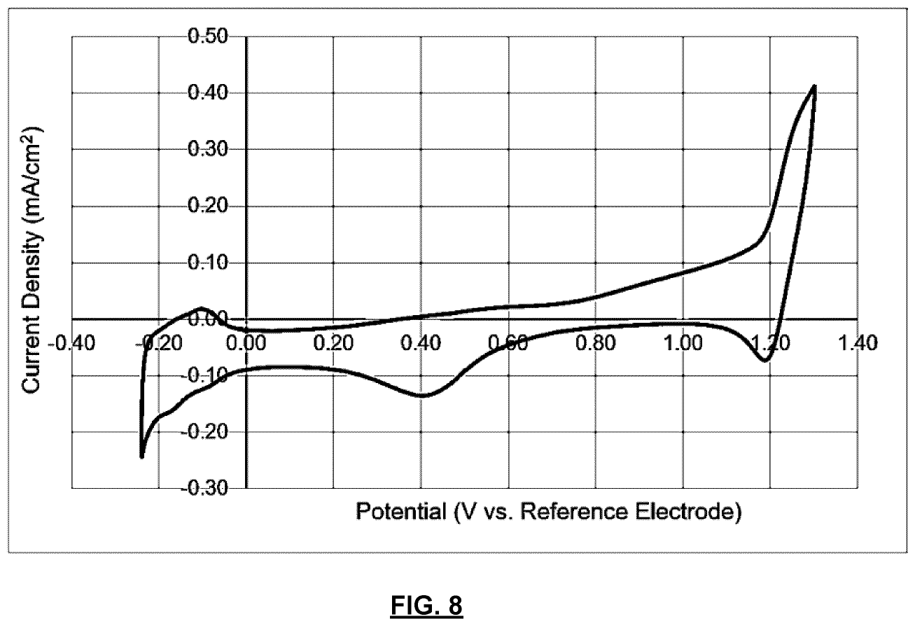

Nitrogen gas (N₂) was bubbled through the electrolyte for 20 minutes to remove dissolved oxygen before testing. Cyclic voltammogram scans were performed in the potential window of −0.24 V and 1.3 V vs. the reference electrode with 5 mV/s scan rate for three cycles to get a stable Cyclic voltammogram curve in the N₂ purged solution (at least two cycles may be used to get a stable curve). FIG. 8 illustrates a cyclic voltammetry curve from one of the cyclic voltammogram scans performed after 20 minutes of N₂ purging.

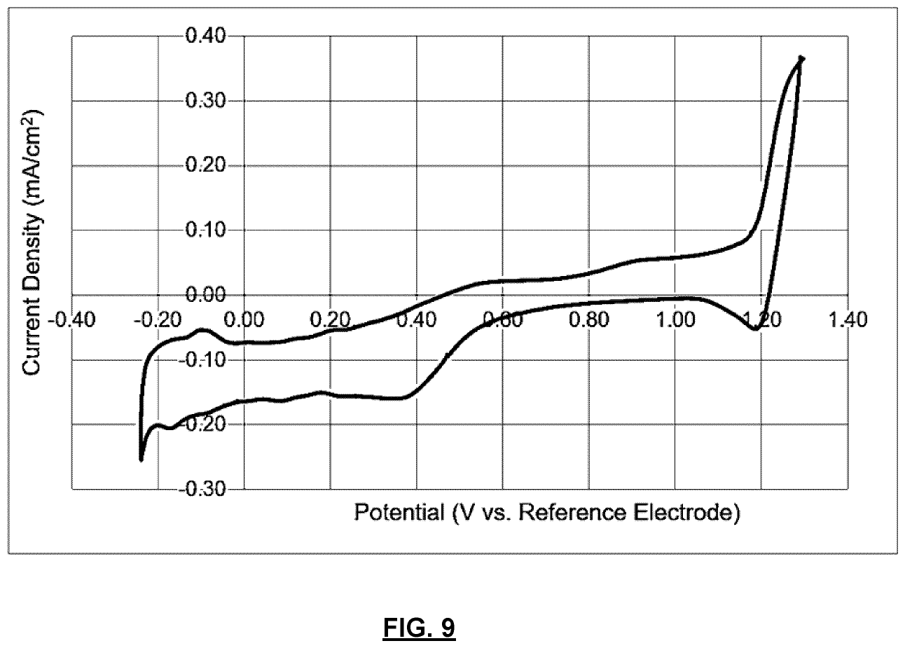

In the oxygen reduction experiments, artificial O₂ gas was used to saturate the electrolyte for a bubbling period of 20-30 minutes before testing. Cyclic voltammogram scans were performed in the potential window of −0.24 V and 1.3 V vs. the reference electrode with 5 mV/s scan rate for one cycle in the artificial O₂/N₂ mixed gas purged solution, and then repeated to obtain repeatable CV curves. FIG. 9 illustrates a cyclic voltammetry curve from one of the cyclic voltammogram scans performed after 30 minutes of purging the electrolyte with an artificial O₂/N₂ mixed gas.

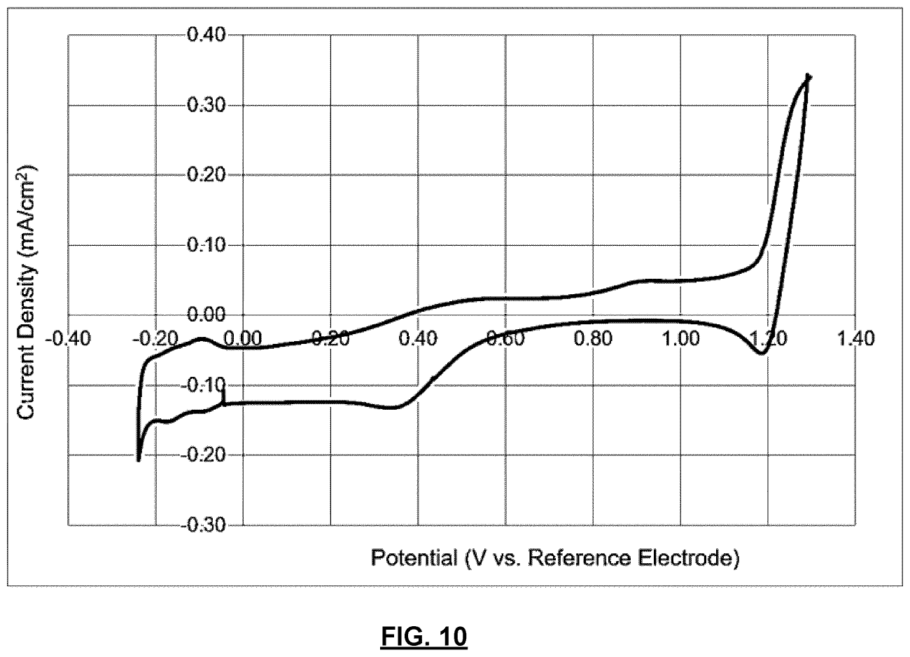

Next, 0.5 ppm SO₂ mixed gas was used to saturate the electrolyte for a bubbling period of 20-30 minutes before testing. Cyclic voltammogram scans were performed in the potential window of −0.24 V and 1.3 V vs. the reference electrode with 5 mV/s scan rate for one cycle in the artificial 0.5 ppm SO₂ mixed gas purged solution, and then repeated to obtain repeatable CV curves. FIG. 10 illustrates a cyclic voltammetry curve from one of the cyclic voltammogram scans performed after 30 minutes of purging the electrolyte with an 0.5 ppm SO₂ mixed gas.

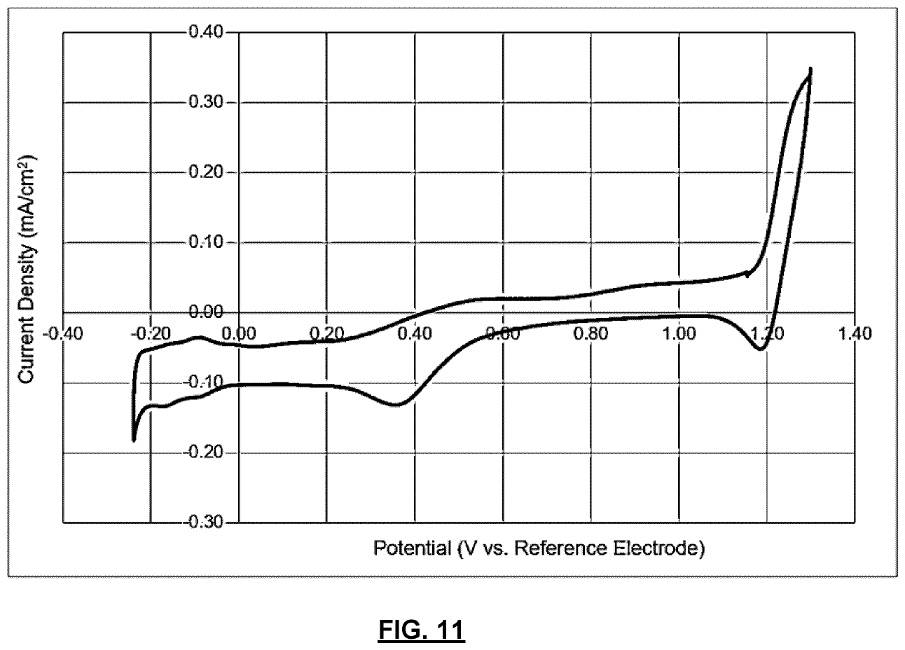

Then, 1 ppm SO₂ mixed gas was used to saturate the electrolyte for a bubbling period of 20-30 minutes before testing. Cyclic voltammogram scans were performed in the potential window of −0.24 V and 1.3 V vs. the reference electrode with 5 mV/s scan rate for one cycle in the artificial 1 ppm SO₂ mixed gas purged solution, and then repeated to obtain repeatable CV curves. FIG. 11 illustrates a cyclic voltammetry curve from one of the cyclic voltammogram scans performed after 30 minutes of purging the electrolyte with a 1 ppm SO₂ mixed gas.

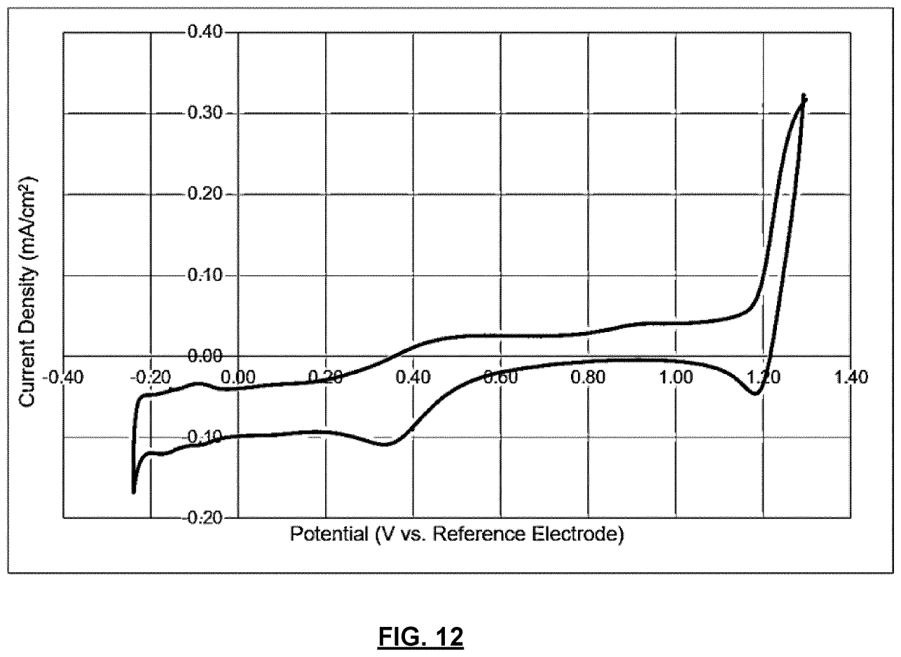

Finally, 2 ppm SO₂ mixed gas was used to saturate the electrolyte for a bubbling period of 20-30 minutes before testing. Cyclic voltammogram scans were performed in the potential window of −0.24 V and 1.3 V vs. the reference electrode with 5 mV/s scan rate for one cycle in the artificial 2 ppm SO₂ mixed gas purged solution, and then repeated to obtain repeatable CV curves. FIG. 12 illustrates a cyclic voltammetry curve from one of the cyclic voltammogram scans performed after 30 minutes of purging the electrolyte with a 2 ppm SO₂ mixed gas.

### Linear Sweep Voltammogram Testing

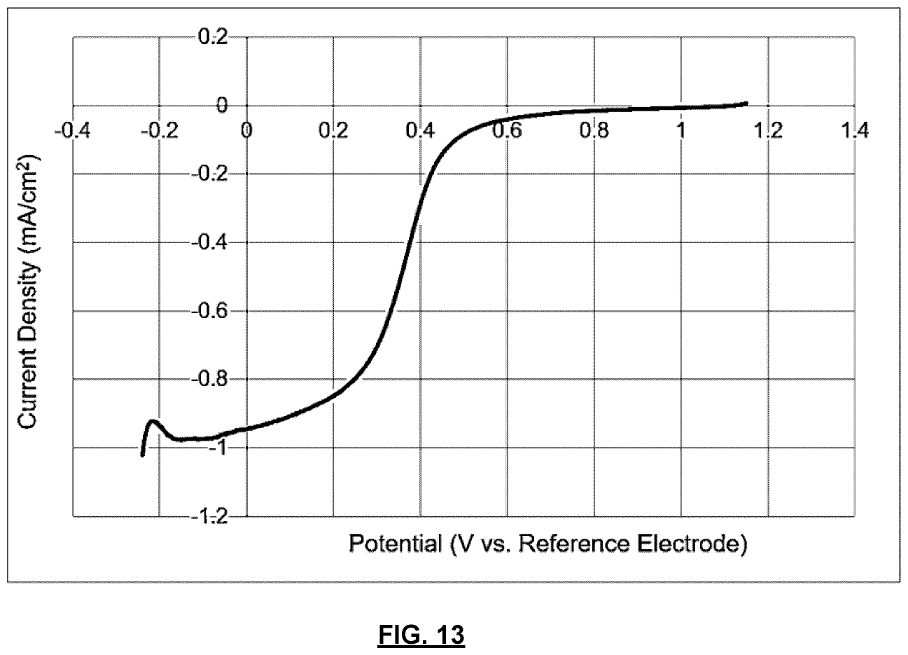

In the oxygen reduction experiments, artificial O₂/N₂ mixed gas was used to saturate the test solution for a bubbling period of 20 minutes before each testing. A linear sweep voltammogram scan was performed in the potential window of −0.24 V and 1.3 V vs. the reference electrode with a 5 mV/s scan rate and 1600 rotations per minutes (rpm) of the rotating disk electrode, and then repeated to obtain repeatable linear sweep voltammogram curves. Each time, the solution was purged for at least 10 minutes to allow for a stable linear sweep voltammogram. FIG. 13 illustrates a linear sweep voltammetry curve from one of the linear sweep voltammogram scans performed after 30 minutes of purging the electrolyte with an artificial O₂/N₂ mixed gas.

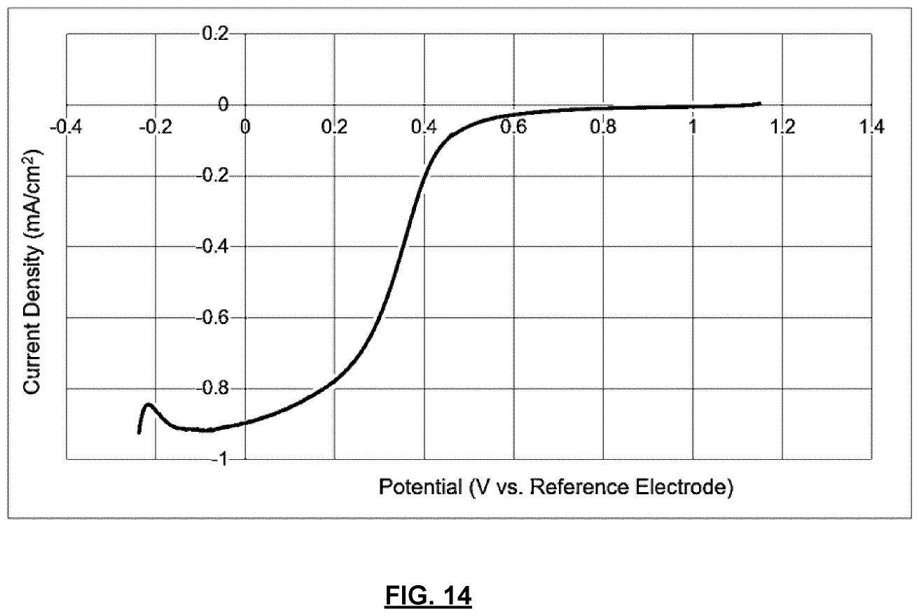

Next, 0.5 ppm SO₂ mixed gas was used to saturate the test solution for a bubbling period of 20 minutes before each testing. A linear sweep voltammogram scan was performed in the potential window of −0.24 V and 1.3 V vs. the reference electrode with a 5 mV/s scan rate and 1600 rotations per minutes (rpm) of the rotating disk electrode, and then repeated to obtain repeatable linear sweep voltammogram curves. Each time, the solution was purged for at least 10 minutes to allow for a stable linear sweep voltammogram. FIG. 14 illustrates a linear sweep voltammetry curve from one of the linear sweep voltammogram scans performed after 30 minutes of purging the electrolyte with a 0.5 ppm SO₂ mixed gas.

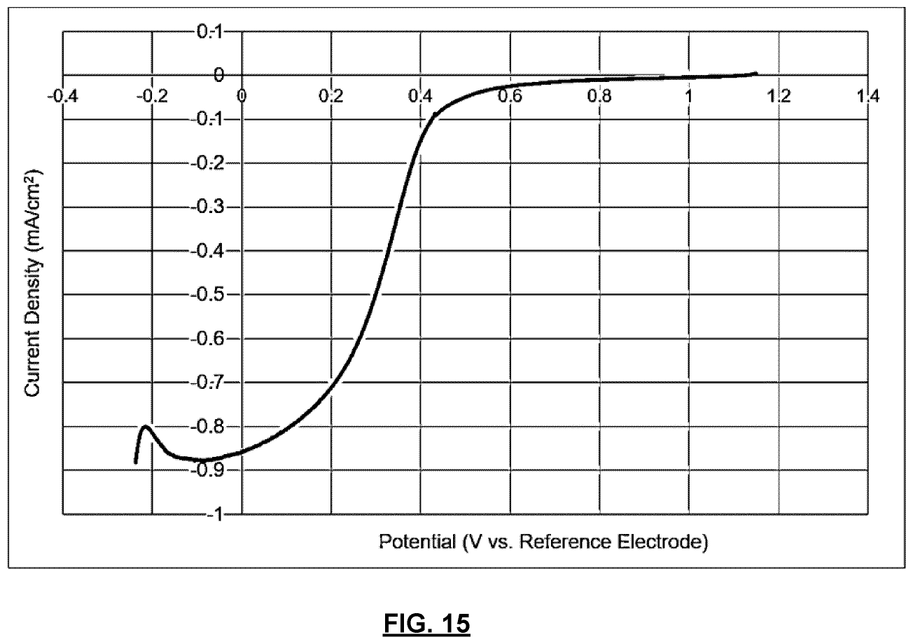

Then, 1 ppm SO₂ mixed gas was used to saturate the test solution for a bubbling period of 20 minutes before each testing. A linear sweep voltammogram scan was performed in the potential window of −0.24 V and 1.3 V vs. the reference electrode with a 5 mV/s scan rate and 1600 rotations per minutes (rpm) of the rotating disk electrode, and then repeated to obtain repeatable linear sweep voltammogram curves. Each time, the solution was purged for at least 10 minutes to allow for a stable linear sweep voltammogram. FIG. 15 illustrates a linear sweep voltammetry curve from one of the linear sweep voltammogram scans performed after 30 minutes of purging the electrolyte with a 1 ppm SO₂ mixed gas.

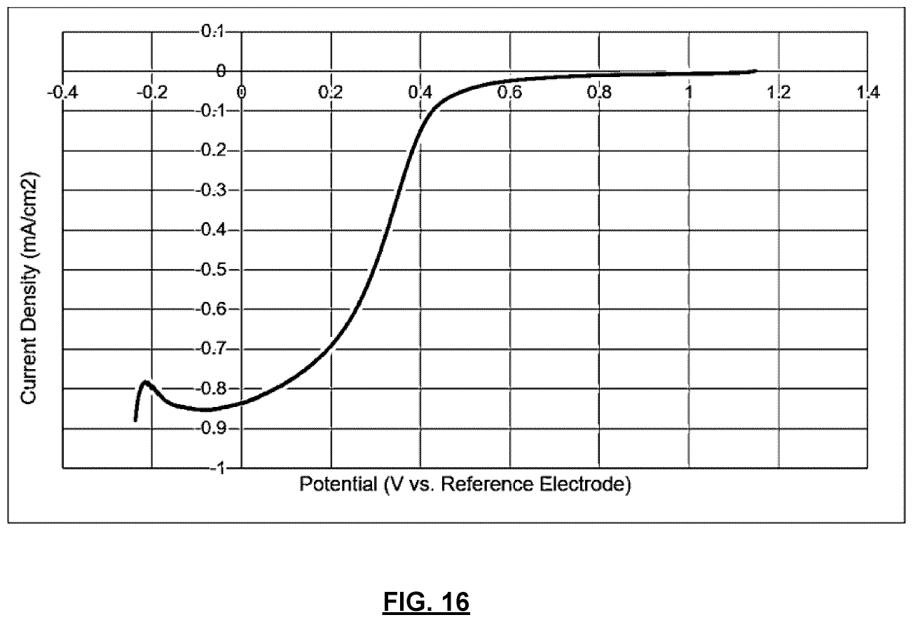

Finally, 2 ppm SO₂ mixed gas was used to saturate the test solution for a bubbling period of 20 minutes before each testing. A linear sweep voltammogram scan was performed in the potential window of −0.24 V and 1.3 V vs. the reference electrode with a 5 mV/s scan rate and 1600 rotations per minutes (rpm) of the rotating disk electrode, and then repeated to obtain repeatable linear sweep voltammogram curves. Each time, the solution was purged for at least 10 minutes to allow for a stable linear sweep voltammogram. FIG. 16 illustrates a linear sweep voltammetry curve from one of the linear sweep voltammogram scans performed after 30 minutes of purging the electrolyte with a 2 ppm SO₂ mixed gas.

### Stability Testing

The electrolyte solution was continuously purged with 2 ppm SO₂ mixed gas for 2-3 days. This was again followed by cyclic voltammogram and linear sweep voltammogram measurements to compare the oxygen reduction performance of the detection electrode before and after long-term purging with 2 ppm SO₂ mixed gas.

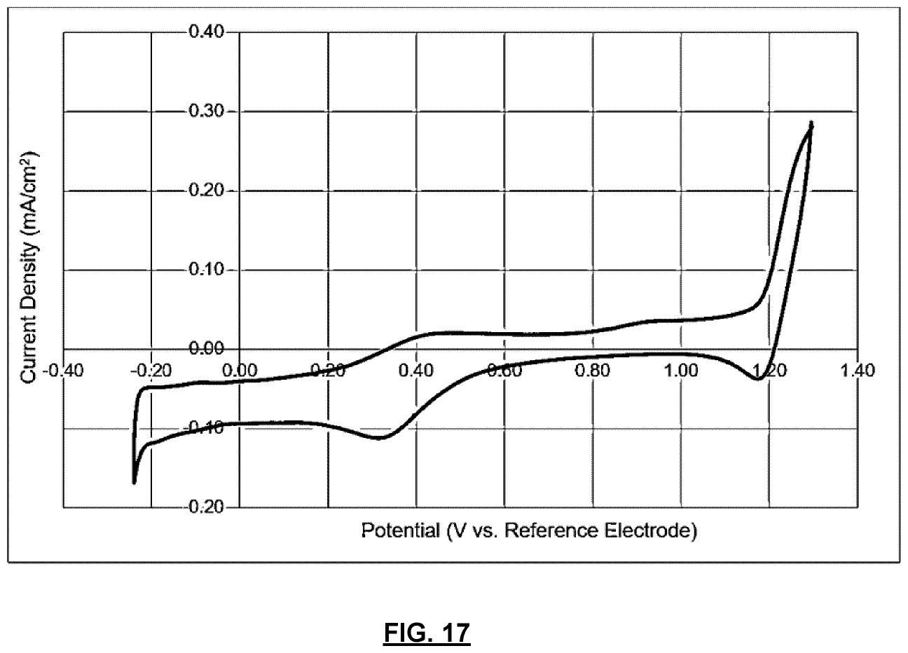

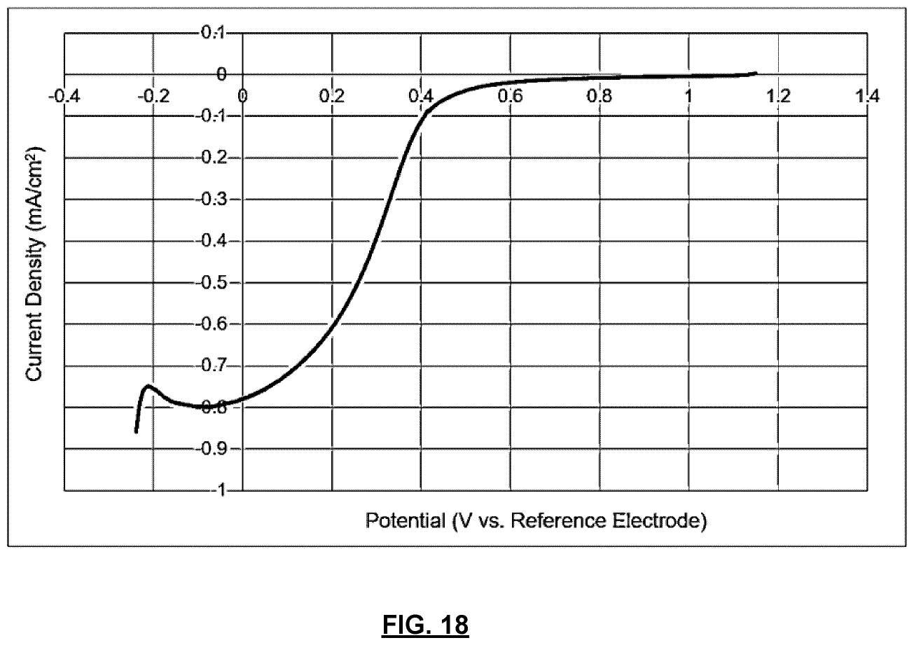

FIG. 17 illustrates a cyclic voltammetry curve from one of the cyclic voltammogram scans performed after 66 hours of purging the electrolyte with a 2 ppm SO₂ mixed gas. FIG. 18 illustrates a linear sweep voltammetry curve from one of the linear sweep voltammogram scans performed after 66 hours of purging the electrolyte with a 2 ppm SO₂ mixed gas.

### Reversibility Test

After scanning the required cyclic voltammograms and linear sweep voltammograms as described above under Cyclic Voltammogram Testing and Linear Sweep Voltammogram Testing, the electrolyte solution was purged with artificial O₂/N₂ mixed gas for 20-30 minutes. This was again followed by cyclic voltammogram and linear sweep voltammogram measurements to compare the oxygen reduction performance of the working electrode before and after the SO₂ contamination tests.

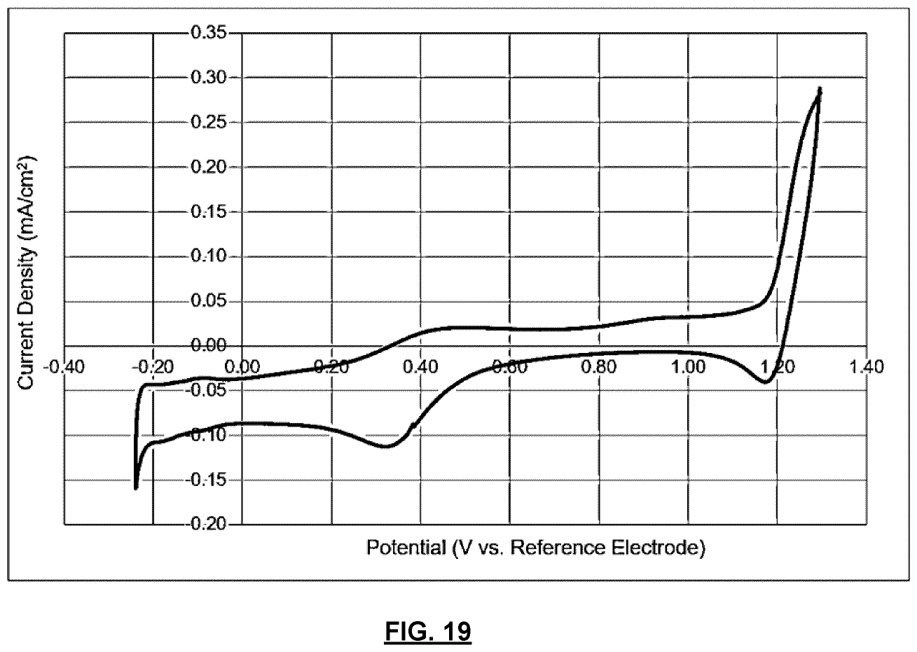

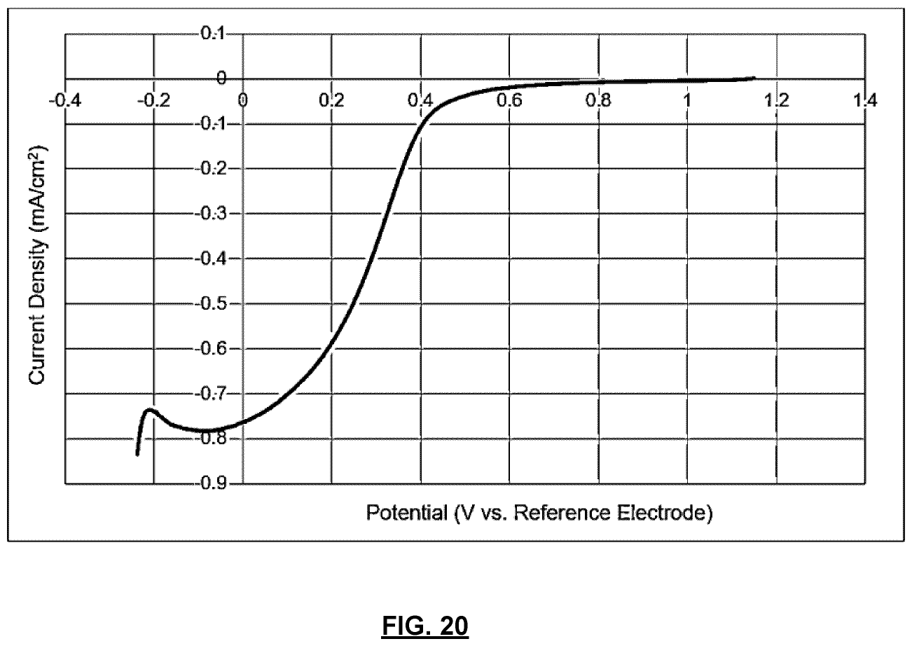

FIG. 19 illustrates a cyclic voltammetry curve from one of the cyclic voltammogram scans performed after 30 minutes of purging the electrolyte with the artificial O₂/N₂ mixed gas after the stability testing. FIG. 20 illustrates a linear sweep voltammetry curve from one of the linear sweep voltammogram scans performed after 30 minutes of purging the electrolyte the artificial O₂/N₂ mixed gas after the stability testing.

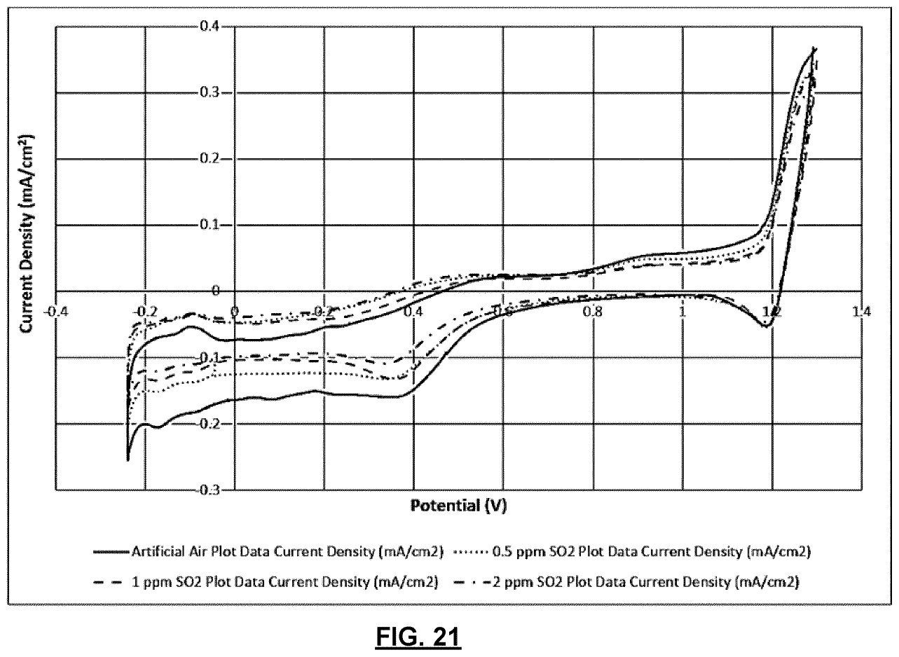

Referring now to FIG. 21, illustrated is a combination of the cyclic voltammogram curves of FIGS. 9 to 12. As exemplified, the artificial air (artificial O₂/N₂ mixed gas) curve reached the highest current density, followed by the SO₂ contamination tests as expected. The electrode exhibited the poorest performance and lowest current densities in the 2 ppm SO₂ test.

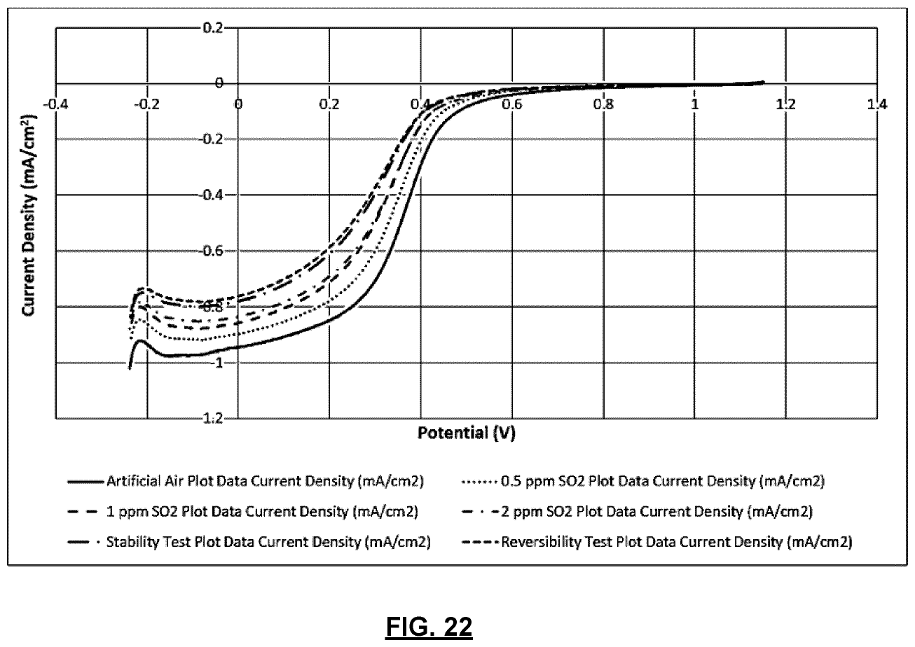

Referring now to FIG. 22, illustrated is a combination of the linear sweep voltammogram curves of FIGS. 13-16, 18, and 20. As exemplified, the linear sweep voltammogram curves are consistent with the cyclic voltammogram results. Among the linear sweep voltammogram curves, the artificial air curve showed the highest performance, which was systematically followed by 0.5 ppm SO₂, 1 ppm SO₂, and then 2 ppm SO₂ curves. The stability test curve and reversibility test curve showed the poorest performance. The LSV curves show that the current densities steadily declined as the SO₂ contamination of the air increased.

The 2 ppm SO₂ stability test indicates that the electrolyte conditions did not change significantly even after continuous purging for more than two days. However, the reversibility test resulted in the poorest performance among all the tests conducted, indicating that the SO₂ contamination changes were irreversible and that the oxygen reduction performance could not be restored after all the SO₂ contamination tests, which may be due to the used/saturated electrolyte or potential catalyst degradation. In some embodiments, the contaminant sensor may be a sacrificial sensor. The contaminant sensor may be a replaceable sensor that is replaced following detecting a contamination.

While the above description provides examples of one or more apparatuses or methods, it will be appreciated that other apparatuses or methods may be within the scope of the accompanying claims.

1. A method for producing a contaminant sensor for use in an air flow path of a fuel cell system upstream of a fuel cell of the fuel cell system, the method comprising:
receiving a sample having a sample composition, the sample composition consisting of one or more components of a catalyst layer of the fuel cell including a catalyst material of the catalyst layer;
forming a sensing element of a detection electrode, the sensing element including the sample; and
assembling the contaminant sensor with a plurality of electrodes, the plurality of electrodes including the detection electrode.

2. The method of claim 1, wherein the sample is received from a third party without receiving a disclosure of the sample composition.

3. The method of claim 2, wherein the sensing element is formed without knowing the sample composition.

4. The method of claim 1, wherein the sample composition comprises the catalyst material and at least one additional component of the catalyst layer of the fuel cell.

5. The method of claim 4, wherein the catalyst material includes platinum.

6. The method of claim 1, further comprising providing the contaminant sensor for installation in the fuel cell system without knowing the sample composition.

7. The method of claim 1, wherein the fuel cell is a proton exchange membrane fuel cell.

8. The method of claim 1, further comprising applying a coating over the sensing element, the coating having a coating composition the same as a membrane composition of a membrane of the fuel cell.

9. The method of claim 1, wherein the fuel cell system is in a vehicle.

10. The method of claim 1, further comprising installing the contaminant sensor in the fuel cell system, wherein the air flow path is a path from an ambient air inlet to the fuel cell to provide ambient air to the fuel cell.

11. A fuel cell system, comprising:
an air flow path extending between a path inlet and a path outlet;
a fuel cell in the air flow path, the fuel cell including a cell catalyst layer having a catalyst layer composition;
a filter in the air flow path upstream of the fuel cell; and
a sensor in the air flow path between the filter and the fuel cell, the sensor having a plurality of electrodes including a detection electrode, the detection electrode including a sensing element having a composition that is the same as the catalyst layer composition of the cell catalyst layer whereby calibration between the sensor output and the fuel cell response is unnecessary.

12. The system of claim 11, wherein the catalyst layer composition is a combination of a plurality of components.

13. The system of claim 12, wherein the catalyst layer composition includes a catalyst material and at least one additional component.

14. The system of claim 1, wherein the fuel cell is a proton exchange membrane fuel cell.

15. The system of claim 1, wherein the detection electrode includes a coating over the sensing element, the coating having a coating composition the same as a membrane composition of a membrane of the fuel cell.

16. The system of claim 1, wherein the fuel cell system is in a vehicle.

17. A method of monitoring for degradation of an intake filter of a fuel cell system, the method comprising:
receiving an output of a contaminant sensor, the contaminant sensor including a detection electrode arranged in an air flow path between the intake filter and a fuel cell of the fuel cell system; and
processing the output of the contaminant sensor to detect a contamination event, without applying a calibration factor to the output, and
wherein the detection electrode includes a sensing element having a composition the same as a catalyst layer composition of a catalyst layer of the fuel cell.

18. The method of claim 17, further comprising generating an alert in response to detecting the contamination event.

19. (canceled)

20. (canceled)

21. (canceled)
